(19) United States
(12) Patent Application Publication
(10) Pub. No.: US 2019/0122160 A1
(43) Pub. Date: Apr. 25, 2019

(54) Software diagnostics and resolution

(71) Applicant: Cloud Assert LLC, Redmond, WA (US)

(72) Inventors: Ravichandhiran Kolandaiswamy, Redmond, WA (US); Aravind Sundaresan, Redmond, WA (US)

(21) Appl. No.: 16/102,710

(22) Filed: Aug. 13, 2018

Related U.S. Application Data
(60) Provisional application No. 62/544,958, filed on Aug. 14, 2017.

(51) Int. Cl. G06Q 10/06; H04L 29/06; G06F 11/36

(52) U.S. Cl. CPC G06Q 10/063112; G06F 11/3688; H04L 63/108; H04L 63/105

(57) ABSTRACT

This application discloses a system for software diagnostics and resolution, including a service on a central machine that accesses target systems such as servers, devices, and any dependent resources, either directly through a native agent, or through a custom agent, or through an agent installed by a third party. The target systems also have the ability to connect remotely to the service on the central machine.

### BACKGROUND

Using software online has many risks and problems. One such problem is that anyone might have access to the software, if they have the password. A second problem is that software developers sometimes also work in operations, in which case they have to provide support in case there are problems with the software. These positions are called DevOps, and the problem is that the DevOps person might have to support problems in software that they did not work on, and the person who worked on it might no longer be available. As such, the DevOps person needs a way to support software that they did not work on. A third problem is that when a software problem is discovered, it is difficult to find the root cause of it, such as how and why it happened. A fourth problem is that sometimes administrators of software have too much power, and use it incorrectly, unnecessarily, or otherwise problematically. A fifth problem is that different levels of organizations have different security clearances and different levels of access, which can cause issues with who is in control of what service and who is responsible for which problem. A sixth problem is when and how to use bots, which are software applications that run automated tasks. A seventh problem is supervising events in real-time, such that they can be stopped or otherwise controlled in the present, instead of waiting for a problem to result. An eighth problem is that administering software can be boring for the administrator, and the administrator's attention needs to be kept. A ninth problem is the lack of a marketplace for publishing issues and providing qualified support by experts offering their service to provide a fix to the issues. A tenth problem is how to validate the qualifications of an expert. An eleventh problem is how to track the reputations of various users, administrators, and experts.

### SUMMARY OF INVENTION

According to one aspect, a system for software diagnostics and resolution enables secure and automated diagnostics, troubleshooting and resolution of issues in a customer's remote environment.

Various implementations and embodiments may comprise one or more of the following. The system supervises DevOps personnel, allows IT admins to restrict access to types of software based on user type and specific user, allows IT admins to restrict the duration of access to software based on user type and specific user, records actions and their effects, analyzes the cause of incidents by utilizing traceability through the recordings of actions, provides recommended actions to DevOps personnel in order to solve incidents, and acts as a passthrough system, thereby having access to all data going into the system.

The foregoing and other aspects, features, and advantages will be apparent to those artisans of ordinary skill in the art from the DESCRIPTION and DRAWINGS, and from the CLAIMS.

### BRIEF DESCRIPTION OF DRAWINGS

The invention will hereinafter be described in conjunction with the appended drawings, where like designations denote like elements, and:

FIG. 1 is a diagram that displays the Diagnostics and Resolution Service.

FIG. 2 is a diagram that displays the Diagnostics and Resolution Service.

FIG. 3 is a diagram that displays the DRS and DRS DevOps Console feedback loop.

FIG. 4 is a diagram that displays the DRS and DRS DevOps Console feedback loop.

FIG. 5 is a diagram that shows the growth of maturity through the use of DRS.

FIG. 6 is a diagram that shows the growth of maturity through the use of DRS.

### DETAILED DESCRIPTION

This disclosure, its aspects and implementations, are not limited to the specific components or assembly procedures disclosed herein. Many additional components and procedures known in the art consistent with the intended system for software diagnostics and resolution service will become apparent for use with implementations of software diagnostics and resolution service from this disclosure.

DevOps is a key term in the latest generation of service and application operations management with the idea to reduce frictions and delays between development phase, deployment phase and various ongoing operations and maintenance phases.

To achieve seamless flow of software in these phases teams use automation, tools, and scripts to enable developer and operations personas to perform various tasks in an automated manner, without requirement of heavy manual processes and thus to avoid delays and human errors.

However, teams, software and processes within each company go through various levels of maturity and stability while trying to achieve more automation and removing manual process.

During the initial phases, often teams start with very less automation and as they progress more tasks are automated. Even when teams start with a suite of automation platforms and DevOps tools out of the box, each application, service, and software is different and has unique set of tasks and challenges that they are not yet aware of all that is needed to be automated. Even if they are aware of all that is needed to be automated at a high level, it is impossible to 100% automate everything that is required now and for future needs.

So teams of all sizes from companies of various categories find themselves at various state of maturity in achieving the DevOps nirvana. Even for a team operating at a higher degree of automation in all the phases, from time to time unforeseen issues in their software or the platform come up, causing failures or degradation that requires manual diagnostics, troubleshooting and resolutions. During these times, teams leverage accessing the resources (Servers, Devices, or Dependent Resources) directly through the resources' native consoles (Remote Desktop, PowerShell Console, SSH Shell etc.) either by accessing inside the target resource or remotely connecting to them to perform required actions. Such tasks are performed either manually or even with semi-automated fashion. In this situation, semi-automated means leveraging some scripted or automated tasks, but the orchestration or sequence of all the steps taken is done manually or more in an exploratory troubleshooting way, and there might even be some guidance documentation to lead the troubleshooting steps, but not adequate to completely figure out the cause of failure nor able to provide confirmed resolution and recovery steps. In such occasions, teams employ such direct approach. After the teams resolve the issue or implement a task, they are asked to analyze and document the root cause of the issue and steps they have taken to implement changes, or steps done to troubleshoot and resolve. Such documentation serves two purposes, first is to make the process repeatable when the same or related issue is met again, the team is prepared to take the required steps with less efforts and in a more automated fashion. Second purpose of such documentation is to feed into the automation pipeline and implement fully or semi-automated scripts and tasks to find such issues proactively and/or when such issue occurs there are fully or semi-automated scripts and tools made available to diagnose and/or resolve the issues with lesser manual orchestration and sequencing of steps needed to be taken.

During these occasions, either when engineers and support personnel are trying to resolve an issue or subsequently analyze root cause and document them, it is left up to the person to remember the exact steps that they have taken and then document them in a manner it is possible for someone else to repeat the same steps without missing or mistaking the commands and parameters used to diagnose and resolve the issue or change requests. Often it is easy for someone to forget or mistype a step or a parameter used in a command executed during troubleshooting and resolution, thus leading to incorrect or partially correct documentation, which finally results in errors and delays.

DRS (Diagnostics and Resolution service) addresses this process and the challenges involved head on by:

Providing a platform where all the steps (manual, semi-automated, automated) done during such diagnostics, troubleshooting and resolution sessions, while implementing change requests on the system, engineers will be performing the steps, executing commands through DRS, via a provided console (DRS DevOps Console).

DRS DevOps Console will let engineers and support personnel use command line commands, scripts, files, and any required access in order to accomplish their tasks. DRS DevOps console will emulate native consoles (such as Remote Desktop, PowerShell, Command Prompt, SSH) and may provide additional tools, contextual help, and intelligence on top of native features. DRS DevOps console and DRS will have access to the target systems (such as Servers, Devices, Dependent resources) either directly, remotely, through an agent installed on the target system or through an intermediate system (such as a Jump Box, Proxy Agent etc.)

DRS DevOps Console will record all the steps taken, commands executed, queries run etc., in real-time or near real-time as the engineer performs the tasks. Optionally the outcome of such commands and tasks can also be recorded (such as success or failure of a command, output of commands or queries etc.)

After the task is completed through the DRS DevOps console or through DRS Service (for unattended sessions), all the actions performed to achieve the desired state is now available for anyone authorized and can be used for auditing purposes or reference in future.

Most importantly after each task is completed, either the engineer who performed those steps, or another engineer who is responsible for automation and development, or optionally DRS itself can now Export the steps and actions performed during the issue resolution or change request sessions, and use the steps and actions for quickly putting together new automation scripts or updating existing scripts to enable quicker less error prone process for same or similar tasks in the future.

Thus, with the DRS DevOps console, the system removes the requirement for the human involvement in remembering or documenting the actions performed during the issue diagnostics, resolution or change request implementation sessions, while providing the flexibility to take any necessary steps to achieve the desired state. Some of the steps may even be documented prior to doing the task, or the steps may be automated, or the steps may be entirely new because the engineer discovered them. DRS DevOps console now captures not only the actions performed but the sequence of actions and optionally the parameters used and outcomes.

DRS DevOps console enables the teams and companies to achieve higher degrees of automation and DevOps maturity by having the flexibility to perform manual or semi-automated tasks when the situation demands without worrying about missing the valuable information about what is done during such sessions; and by capturing and providing the feedback and input to further enhance and improve the automation scripts and systems.

DRS DevOps console combines the above features with other related features such as Role Based Access Control, Just In-Time Access, Just Enough Access, White Listed or Black Listed allowable actions and commands, Integration with existing system (such as ticketing, support, access control etc.) and Realtime Collaborative sessions.

The Online software as a service Diagnostics and Resolution service (“the system”) provides a variety of solutions to the problems discussed in the background. It is unique in that it acts as a passthrough, such that all data goes in and out of it, and thus offers a higher level of security than software with more limited access.

One embodiment of the system solves the first problem mentioned in the background by restricting access, such that instead of providing no time limit access to anyone with a username and password, the system has on demand access, such that users and administrators have access to what they need for the amount of time they need it, but no longer.

One embodiment of the system solves the second problem mentioned in the background by enabling on-call developer or operations support or DevOps personnel to be able to respond to incidents that may not have prior experience themselves solving. The system does this by providing recommended actions for incidents and trouble shooting. In one embodiment of the invention, the system will predict and predict and recommend possible resolution steps based on its historical data by utilizing machine learning and data analytics. So, the system will keep track of previous attempted resolutions, determine how successful they were, and based on that historical data and analytics, recommend a solution to the user, with possible percentage success rates, as well as user feedback for each possible solution. This will give confidence to any on-call support personnel that they will be able to get pointers and recommendations on how to fix the system if necessary.

One embodiment of the system solves the third problem mentioned in the background by providing an auditing feature, which allows for traceability and accountability. The system is passthrough, so that all data used in any software that is part of the system, goes through the system, and all of that data is recorded. This allows any issues that occur in a later stage of a project to be traced back to actions performed in the past, and to identify who and why the decision was made that led to the creation of the issue.

One embodiment of the system solves the fourth problem mentioned in the background by providing, just enough administration and just in time administration. This limits administrators and users to tools that they actually need, and access to those tools for a limited duration.

One embodiment of the system solves the fifth problem mentioned in the background by giving the IT admin the power to limit the software and duration of access to software for each type of user and specific users, such that there is clarity about who has access to what.

One embodiment of the system solves the sixth problem mentioned in the background by letting the IT admin decide when and how bots will respond, whether bots will automatically take action, or whether a DevOps person will be automatically called, and which DevOps person will be called.

One embodiment of the system solves the seventh problem mentioned in the background by providing live sessions for IT admins and other users, such that screen sharing is possible, and troubleshooting can take place with multiple users, and each user can either:
a. Passively watch and monitor, or
b. Actively participate and run commands
c. Shadow and get training

One embodiment of the system solves the eighth problem mentioned in the background by making IT fun and making operations fun through gamification, that is, turning the IT process into a game.

One embodiment of the system solves the ninth problem mentioned in the background by creating a marketplace for publishing issues and qualified support experts offering their service to fix issues. The system does this by using fundamental constructs for allowing secured, approval based, policy based commands, actions and executions.

One embodiment of the system solves the tenth problem mentioned in the background by requiring experts to have certain credentials, proving that they are validated.

One embodiment of the system solves all the problems mentioned in the background, by utilizing all of the methods described above.

The different actors and parts of the system are listed as follows:
a. IT Admins
   i. Subset: Configuration or Service Admins who have access to how the system behaves
b. DevOps person: Developers or Operations support personnel
c. Support Agents
d. Managers or Supervisors
e. Management
f. Hosting service provider
g. Target system.
   Each of these actors and parts of the system can receive different access to different software for different durations of time. The configuration or service admins are able to set those limits and control the access and duration of software to each type of user, as well as each specific user.

There are 2 delivery methods for the system, Software as a service or On-site. Software as a service is a term understood in the art as a software delivery model in which software is licensed on a subscription basis, and is centrally hosted, as in not hosted at the client site. In contrast, on-site refers to installing software on the client's hardware, and so is not centrally hosted. On-site may still be licensed on a subscription basis.

Some additional features of the system are as follows. Any agent or DevOps person must go through the system, there will be no data access of the software that is part of the system, without going through the system. This is called a passthrough system. This allows credentials to not be required to be known or shared with an agent. Also, credentials and other settings and configurations can be stored in a centralized location.

In the event of an incident, which is a need for someone to do something on the system, an agent (any actor) will request access to the system. An approver can be an IT admin or can be the system itself, and can approve the agent's access. If approved, the agent is allowed to access the system.

The system may identify incidents without the need for a human being to be involved, and if so the system will automatically create a request for access on behalf of the on-call agent as soon as such an incident occurs. An on-call agent is an actor who is tasked with monitoring incidents and dealing with incidents as they occur, for a limited time period, during which the agent is described as being on-call.

Approval can be configured for manual approval by an approver or auto-approved depending on requested access level, agent, target system and configurations.

Approved access may have an expiration time limit and number of times of access limits.

An agent can either execute or run:
1. Pre-determined white-listed set of commands and/or programs on or against the target system
2. Depending on the access level, able to execute “any” commands and programs on the target system (not just the white-listed set of commands)
3. System also supports black-listing sets of commands depending on the access level or authorization given. Black-listed commands are programs that will denied.

All actions done by an agent or DevOps person are recorded before they are executed, which includes details about the action, approval and authorization. The execution outcome is also recorded. The actions that are recorded may be played back at a later stage, either manually or automatically if configured.

Data about the actions and outcomes can be analyzed for positive and negative elements. The system may use data analysis and machine learning to come up with the sequence of actions under various categories. Actions that result in positive outcomes may be identified, and used to analyze future actions. Actions that result in dangerous outcomes may be identified, and used to analyze future actions for dangerous patterns. In such cases, if there is time, the system may stop such actions that result to dangerous outcomes from executing.

The system may offer predictions based on past data. For example, in a given environment, with other given input conditions, the system may list possible actions to take. The system may show a list of possible actions or recommended actions, along with points and ratings that indicate the likelihood of success of such an action. These points and ratings may be based on the probability of success for a given action for a given scenario.

In one embodiment of the invention, there is an incident in which a web server is not responding. The system responds with these recommendations, points and ratings:
1. Unblock Port 80 and 443 [Success Rating: *** (3stars)/90% of time people with similar issues took this action]
2. Restart Web Server Service [Success Rating: **** (4stars)/20% of time people with similar issues took this action after taking action]

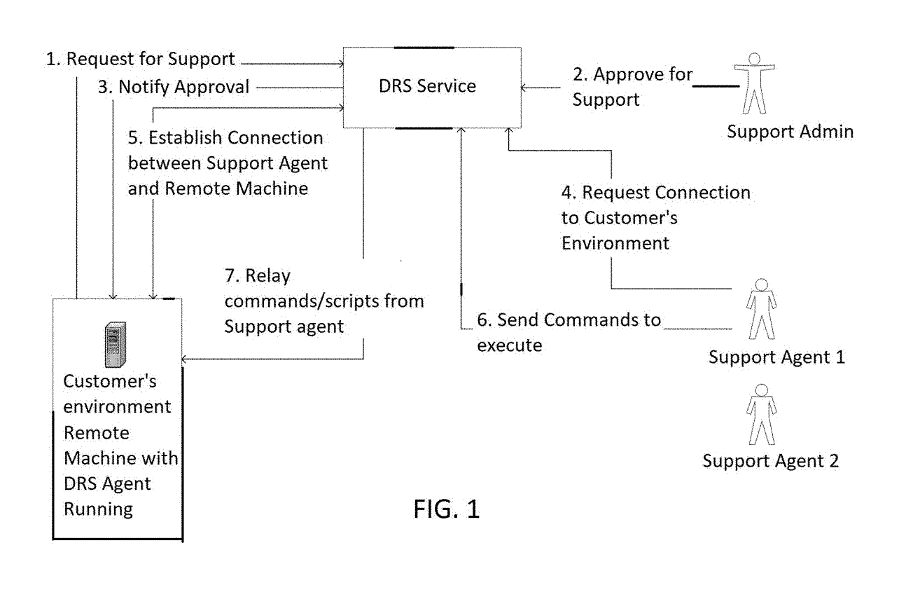

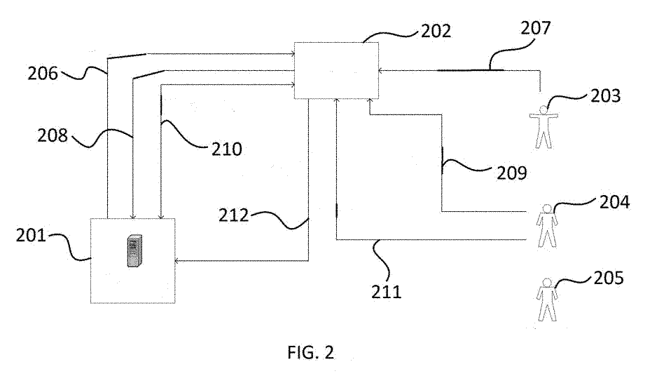

FIG. 1 shows one embodiment of the invention. FIG. 2 shows the same embodiment of the invention, which is described as follows. 201 is a remote customer machine with either the system's agent running on the remote customer's machine, or access given to the 202 central machine to access the 201 remote customer machine. The system's agent can be either a native agent, or a custom agent, or an agent installed by a third party. 202 is a central machine with the system's service running on the central machine. 202 can either be in the cloud and operate through software as a service, or can be hosted at the customer's site. 203 is a support admin. 204 is support agent 1. 205 is support agent 2. 206 is the first step in a chain, and is a request for support by 201 to 202. 207 is the second step in the chain, and is an approval of support from 203 to 202. 208 is the third step in the chain, and is a notification of approval from 202 to 201. 209 is the fourth step in the chain, and is a support agent, either 204 or 205, requesting connection to a customer's environment from 204 to 202. 210 is the fifth step in the chain, and is the establishment of a connection between the support agent and the remote machine from 202 to 201. 211 is the sixth step in the chain, and is a support agent, either 204 or 205, sending commands to execute from 204 to 202. 212 is the seventh step in the chain, and is the system's service relaying commands or scripts from the support agent, from 202 to 201.

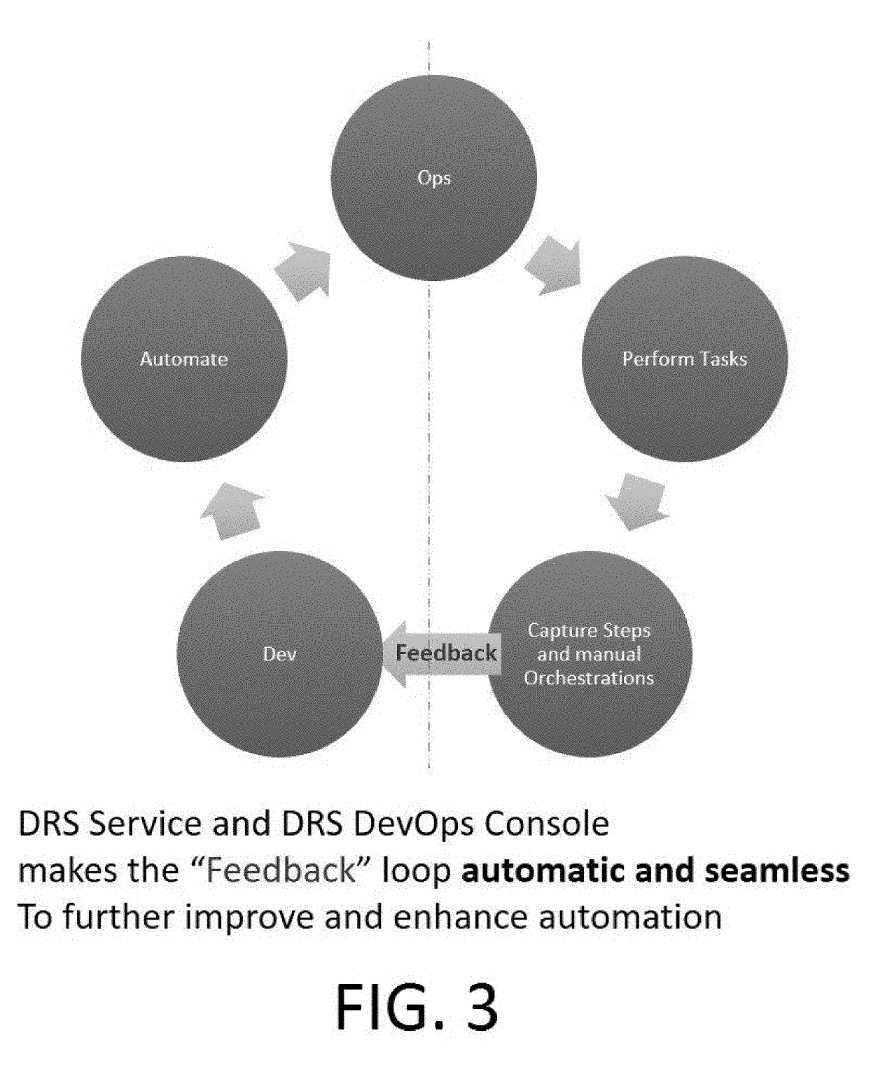

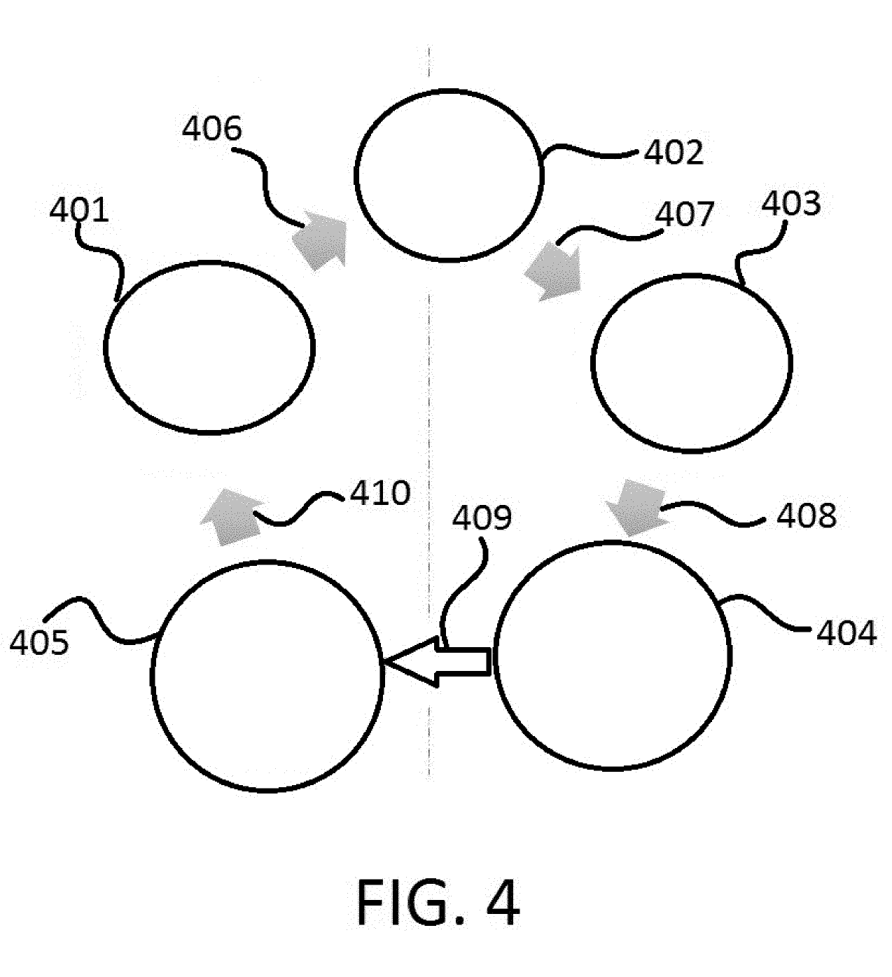

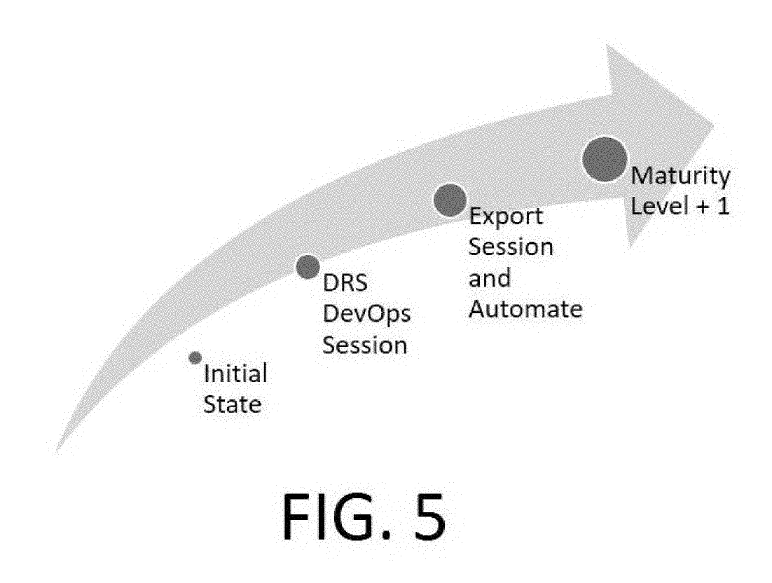

FIG. 3 shows one embodiment of the invention, and shows how DRS and DRS DevOps Console makes a feedback loop that is automatic and seamless, which further improves and enhances automation. FIG. 4 shows the same embodiment of the invention, which is described as follows. 401 is the automate stage of the loop, in which DRS DevOps Console will record all the steps taken, commands executed, queries run etc., in real-time or near real-time as the engineer performs the tasks. Optionally the outcome of such commands and tasks can also be recorded (such as success or failure of a command, output of commands or queries etc.) 402 is the Ops step, in which all the actions performed to achieve the desired state is available for anyone authorized and can be used for auditing purposes or reference, and either the engineer who performed those steps, or another engineer who is responsible for automation and development, or optionally DRS itself can now export the steps and actions performed during the issue resolution or change request sessions, and use the steps and actions for quickly putting together new automation scripts or updating existing scripts to enable quicker less error prone process for same or similar tasks in the future. 403 is the Perform Tasks step, in which the chosen steps are performed, either on the central machine or on the target systems, depending on what an engineer specifies. 404 is the capture steps and manual orchestrations stage of the loop, in which either when engineers and support personnel are trying to resolve an issue or subsequently analyze root cause and document them, someone remembers the exact steps that they have taken and then documents them in a manner such that it is possible for someone else to repeat the same steps without missing or mistaking the commands and parameters used to diagnose and resolve the issue or change requests. 405 is the initial development step, in which teams may start with a suite of automation platforms and DevOps tools out of the box, and each application, service and software is different and has unique set of tasks and challenges that they are not yet aware of all that is needed to be automated. 409 is the feedback step, in which the captured steps are incorporated into DRS and DRS DevOps, such that they may be used by the programmers and other technical personnel. 410 is the transition between the initial development step 405 and the automate step 401. 406 is the transition between the automate step and the Ops step. 407 is the transition between the Ops step and the perform tasks step. 408 is the transition between Perform tasks step and the capture steps and manual orchestrations stage.

The customer delegates a DevOps person, who interacts with the system's service. The DevOps person requests access. The system's service determines if the user has requisite privileges based on predefined role or privileges setup by IT admins. The user can request additional privileges on demand. The IT admins get an approval request. Either the system's service or the IT admins approve the request. Upon approval, the user gets access to certain software for a predetermined amount of time, after which access will expire. The user can execute commands, which are recorded remotely and stored in the system's service. These recordings can be used for auditing and replaying purposes. After the access time expires, if remote desktop or screen share is used, then the remote desktop session will be recorded. The set of scripts stored on the server can be transferred or stored to the client's side. Each script can be a series of commands or workflows, which can be grouped together to troubleshoot or diagnose and resolve issues. Each of these steps can be made conditional based on results from the previous steps.

One of the benefits of the system is that it allows for credential-less administration, that is, the end user never gets access to any credentials. Another benefit is that if multiple users join a particular session, the client user will lie able to provide the requisite credentials to execute the script, which will be executed in the client system, and the non-credentialed users will not see the credentials. A third benefit is that the support agent doesn't know the credentials. A fourth benefit is the IT admins can configure commands disallowed to be executed through a mechanism to restrict what can be executed. A fifth benefit is that the session or channel listens to the server first, the channel gets created with an agent only after approval of the request. A sixth benefit is that commands can be executed individually or as a batch. A seventh benefit is that there is a mechanism to send scripts and related resources automatically to enable execution in the target computer, because all customer machines run the system's agent, which listens to commands from the system's service.

The main functionalities are:
1. Authentication and Authorization for various Roles (Systems, People, Process)
2. Approval Workflow
3. On-Demand Access
4. Timely Expiration and Lockout of Access
5. Credentials and Settings Secured Storage
6. Commands, Scripts and Automation: Centralized Storage and Platform for Execution
7. Secured Pass-through for all actions, commands and executions; acting like a proxy
8. Everything is Recorded before execution: Auditing, Compliance, Analytics
9. Playback, Enable faster resolutions of issues over time
10. Analytics and Machine Learning: Predictive Recommendations
11. Live Sessions:
   a. Multiple parties can be on the same troubleshooting session
   b. Monitoring

It will be understood that implementations are not limited to the specific components disclosed herein, as virtually any components consistent with the intended operation of a method and/or system implementation for a recreational power and stabilizing apparatus may be utilized. Accordingly, for example, although particular biased members, handles, and the like may be disclosed, such components may comprise any shape, size, style, type, model, version, class, grade, measurement, concentration, material, weight, quantity, and/or the like consistent with the intended operation of a method and/or system implementation for a recreational power and stabilizing apparatus may be used.

In places where the description above refers to particular implementations of a recreational power and stabilizing apparatus, it should be readily apparent that a number of modifications may be made without departing from the spirit thereof and that these implementations may be applied to other recreational power and stabilizing apparatus. The accompanying claims are intended to cover such modifications as would fall within the true spirit and scope of the disclosure set forth in this document. The presently disclosed implementations are, therefore, to be considered in all respects as illustrative and not restrictive, the scope of the disclosure being indicated by the appended claims rather than the foregoing description. All changes that come within the meaning of and range of equivalency of the claims are intended to be embraced therein.

What is claimed is:

1. A system for software diagnostics and resolution, the system comprising:
a service on a central machine;
the ability of the service on the central machine to access the target systems, such as servers, devices, and any dependent resources, either directly through a native agent, or through a custom agent, or through an agent installed by a third party;
the ability of the target systems to connect remotely to the service on the central machine;
wherein communication between the central service and either the agent or the target systems can be either real-time or message based, and can be either Pull or Push model,
wherein the Push model is a service that sends a message to either the target systems or to the agent service without needing the agent to poll, and the Pull model allows either the agent or the target systems to periodically poll for new messages, or poll for messages based on various triggers;
wherein the target systems can run scripts and commands locally that are sent from the service on the central machine;
wherein the service on the central machine allows IT admins to supervise DevOps personnel by following DevOps personnel actions live or through recordings,
wherein the service on the central machine allows IT admins to restrict access to types of soft ware based on user type and specific user,
wherein the service on the central machine allows IT admins to restrict the duration of access to target systems based on user type and based on specific user,
wherein the service on the central machine records actions and their effects on customer machines,
wherein the service on the central machine analyzes the cause of incidents by utilizing traceability through the recordings of actions,
wherein the service on the central machine provides recommended actions to DevOps personnel in order to solve incidents,
wherein the service on the central machine is a passthrough system and thereby has access to all data going into the system.

2. The system of claim 1,
wherein the different user types that IT admins can separate access by comprises:
a. IT Admins
i. Subset: Configuration or Service Admins who have access to how the system behaves
b. DevOps person: Developers or Operations support personnel
c. Support Agents
d. Managers or Supervisors
e. Management
f. Hosting service provider
g. Target system
h. External experts
i. Agents registered via an Integrated marketplace experience offered by the system of claim 1, and identifiable by skill or expertise or reputation.

3. The system of claim 1,
wherein the system constantly analyzes and builds the reputation for personnel who have used or are using the system based on past success rates, time taken, and user feedback;
wherein the system builds known skillsets and expertise for personnel who have used or are using the system based on the list of actions that personnel who have used or are using the system have taken, which is stored as data;
wherein the system uses the reputation, skillsets and expertise to recommend personnel for certain tasks;
wherein the system uses the reputation, skillsets and expertise to advertise the personnel with those skillsets and expertise,
wherein the system uses the reputation, skillsets and expertise to find the correct personnel for a task that a user wants to get done.

4. The system of claim 1,
wherein the service on the central machine predicts and recommends possible resolution steps based on its historical data by utilizing machine learning and data analytics;
wherein the service on the central machine will keep track of previous attempted resolutions, determine how successful they were, and based on that historical data and analytics, recommend a solution to the user;
wherein the recommendation will have possible percentage success rates, as well as user feedback for each possible solution.

5. The system of claim 1,
wherein the system provides live sessions for IT admins and other users, such that session sharing or screen sharing, or both session sharing and screen sharing is possible, and troubleshooting can take place with multiple users, and each user can either:
a. Passively watch and monitor, or
b. Actively participate and run commands, or
c. Shadow and get training.

6. The system of claim 1,
wherein the system offers predictions based on past data, such that in a given environment, with other given input conditions, the system may list possible actions to take;
wherein the system shows a list of possible actions or recommended actions, along with points and ratings that indicate the likelihood of success of such an action;
wherein the points are based on the probability of success for a given action for a given scenario;
wherein the ratings are based on user feedback and comments.

7. The system of claim 1,
wherein the service on the central machine allows IT admins to configure when and how bots will respond, whether bots will automatically take action, or whether a DevOps person will be automatically called, and which DevOps person will be called.

8. The system of claim 1,
wherein the system uses data analysis and machine learning to come up with the sequence of actions under various categories,
actions that result in positive outcomes may be identified, and used to analyze future actions,
actions that result in dangerous outcomes may be identified, and used to analyze future actions for dangerous patterns, and in such cases, if there is time, the system may stop such actions that result in dangerous outcomes from executing.

9. The system of claim 1,
wherein the central machine with the system's service running on the central machine can either be in the cloud and operate through software as a service, or can be hosted at the customer's site;
wherein there is a support admin;
wherein there is a support agent;
wherein there is a request for support by an agent on a customer machine to the service on the central machine;
wherein there is an approval of support from the support admin to the service on the central machine;
wherein there is a notification of approval from the service on the central machine to the agent on a customer machine;
wherein a support agent requests connection to the customer machine's environment from the service on the central machine;
wherein there is an establishment of a connection between the support agent and the customer machine through the service on the central machine;
wherein a support agent sends commands to execute on the service on the central machine;
wherein the service on the central machine relays commands or scripts from the support agent to the customer machine.

10. The system of claim 1,
wherein the service on the central machine provides a platform where manual, semi-automated and automated steps are done during diagnostics, troubleshooting and resolution sessions;
wherein the service on the central machine implements change requests on the system;
wherein the service on the central machine executes commands via a provided console (DRS DevOps Console);
wherein the DRS DevOps Console will let engineers and support personnel use command line commands, scripts, files and any required access in order to accomplish their tasks;
wherein the DRS DevOps Console will offer Remote Desktop services, PowerShell options, Command Prompt access, and secure shell (SSH) access;
wherein the DRS DevOps Console provide contextual help and intelligence on top of native features;
wherein the DRS DevOps Console and the service on the central machine will have access to the target systems either directly, remotely, through an agent installed on the target system or through an intermediate system;
wherein the DRS DevOps Console will record all the steps taken, commands executed, and queries run in real-time or near real-time as the engineer performs the tasks;
wherein the outcome of such commands can also be recorded, including the success or failure of a command, and the output of a command;
wherein after a command is completed through the DRS DevOps console, or through the Service on the central machine for unattended sessions, all the actions performed to achieve the desired state are available for anyone authorized;
wherein the steps and actions performed during the issue resolution or change request sessions can be exported and used for quickly putting together new automation scripts or updating existing scripts to enable quicker and less error prone processes for the same or similar tasks in the future;
wherein DRS DevOps console also provides Role Based Access Control, Just In-Time Access, Just Enough Access, White Listed or Black Listed allowable actions and commands, and Realtime Collaborative sessions.

11. The system of claim 2,
wherein the system constantly analyzes and builds the reputation for personnel who have used or are using the system based on past success rates, time taken, and user feedback;
wherein the system builds known skillsets and expertise for personnel who have used or are using the system based on the list of actions that personnel who have used or are using the system have taken, which is stored as data;
wherein the system uses the reputation, skillsets and expertise to recommend personnel for certain tasks;
wherein the system uses the reputation, skillsets and expertise to advertise the personnel with those skillsets and expertise,
wherein the system uses the reputation, skillsets and expertise to find the correct personnel for a task that a user wants to get done.

12. The system of claim 11,
wherein the service on the central machine predicts and recommends possible resolution steps based on its historical data by utilizing machine learning and data analytics;
wherein the service on the central machine will keep track of previous attempted resolutions, determine how successful they were, and based on that historical data and analytics, recommend a solution to the user;
wherein the recommendation will have possible percentage success rates, as well as user feedback for each possible solution.

13. The system of claim 12,
wherein the system provides live sessions for IT admins and other users, such that session sharing or screen sharing, or both session sharing and screen sharing is possible, and troubleshooting can take place with multiple users, and each user can either:
a. Passively watch and monitor, or
b. Actively participate and run commands, or
c. Shadow and get training;
wherein the system offers predictions based on past data, such that in a given environment, with other given input conditions, the system may list possible actions to lake;
wherein the system shows a list of possible actions or recommended actions, along with points and ratings that indicate the likelihood of success of such an action;
wherein the points are based on the probability of success for a given action for a given scenario;
wherein the ratings are based on user feedback and comments.

14. The system of claim 13,
wherein the service on the central machine allows IT admins to configure when and how bots will respond, whether bots will automatically take action, or whether a DevOps person will be automatically called, and which DevOps person will be called;
wherein the system uses data analysis and machine learning to come up with the sequence of actions under various categories,
actions that result in positive outcomes may be identified, and used to analyze future actions,
actions that result in dangerous outcomes may be identified, and used to analyze future actions for dangerous patterns, and in such cases, if there is time, the system may stop such actions that result in dangerous outcomes from executing;
wherein the central machine with the system's service running on the central machine can either be in the cloud and operate through software as a service, or can be hosted at the customer's site;
wherein there is a support admin;
wherein there is a support agent;
wherein there is a request for support by an agent on a customer machine to the service on the central machine;
wherein there is an approval of support front the support admin to the service on the central machine;
wherein there is a notification of approval from the service on the central machine to the agent on a customer machine;
wherein a support agent requests connection to the customer machine's environment from the service on the central machine;
wherein there is an establishment of a connection between the support agent and the customer machine through the service on the central machine;
wherein a support agent sends commands to execute on the service on the central machine;
wherein the service on the central machine relays commands or scripts from the support agent to the customer machine.

15. A system for software diagnostics and resolution, the system comprising:
a service on a central machine;
the ability of the service on the central machine to access the target systems, such as servers, devices, and any dependent resources, either directly through a native agent, or through a custom agent, or through an agent installed by a third party;
the ability of the target systems to connect remotely to the service on the central machine;
wherein communication between the central service and either the agent on the target systems or the target systems themselves, can be either real-time or message based, and can be either Pull or Push model, wherein the Push model is a service that sends a message either to the target systems or to the agent service without needing the agent to poll, and the Push model allows either the agent or the target systems to periodically poll for new messages, or poll for messages based on various triggers;
wherein the target systems can run scripts and commands locally that are sent from the service on the central machine;
wherein the service on the central machine allows IT admins to supervise DevOps personnel by following DevOps personnel actions live or through recordings,
wherein the service on the central machine allows IT admins to restrict access to types of software based on user type and specific user,
wherein the service on the central machine allows IT admins to restrict the duration of access to target systems based on user type and based on specific user,
wherein the service on the central machine records actions and their effects on customer machines,
wherein the service on the central machine analyzes the cause of incidents by utilizing traceability through the recordings of actions,
wherein the service on the central machine provides recommended actions to DevOps personnel in order to solve incidents,
wherein the service on the central machine is a passthrough system and thereby has access to all data going into the system;
wherein the different user types that IT admins can separate access by comprises:
a. IT Admins
i. Subset: Configuration or Service Admins who have access to how the system behaves
b. DevOps person: Developers or Operations support personnel
c. Support Agents
d. Managers or Supervisors
e. Management
f. Hosting service provider
g. Target system
h. External experts
i. Agents registered via an Integrated marketplace experience offered by the system of claim 1, and identifiable by skill or expertise or reputation;
wherein the system constantly analyzes and builds the reputation for personnel who have used or are using the system based on past success rates, time taken, and user feedback;
wherein the system builds known skillsets and expertise for personnel who have used or are using the system based on the list of actions that personnel who have used or are using, the system have taken, which is stored as data;
wherein the system uses the reputation, skillsets and expertise to recommend personnel for certain tasks;
wherein the system uses the reputation, skillsets and expertise to advertise the personnel with those skillsets and expertise,
wherein the system uses the reputation, skillsets and expertise to find the correct personnel for a task that a user wants to get done;
wherein the service on the central machine predicts and recommends possible resolution steps based on its historical data by utilizing machine learning and data analytics;
wherein the service on the central machine will keep track of previous attempted resolutions, determine how successful they were, and based on that historical data and analytics, recommend a solution to the user;
wherein the recommendation will have possible percentage success rates, as well as user feedback for each possible solution;
wherein the system provides live sessions for IT admins and other users, such that session sharing or screen sharing, or both session sharing and screen sharing is possible, and troubleshooting can take place with multiple users, and each user can either:
a. Passively watch and monitor, or
b. Actively participate and run commands, or
c. Shadow and get training;
wherein the system offers predictions based on past data, such that in a given environment. with other given input conditions, the system may list possible actions to take;
wherein the system shows a list of possible actions or recommended actions, along with points and ratings that indicate the likelihood of success of such an action;
wherein the points are based on the probability of success for a given action for a given scenario;
wherein the ratings are based on user feedback and comments;
wherein the service on the central machine allows IT admins to configure when and how bots will respond, whether bots will automatically take action, or whether a DevOps person will be automatically called, and which DevOps person will be called;
wherein the system uses data analysis and machine learning to come up with the sequence of actions under various categories,
actions that result in positive outcomes may be identified, and used to analyze future actions,
actions that result in dangerous outcomes may be identified, and used to analyze future actions for dangerous patterns, and in such cases, if there is time, the system may stop such actions that result in dangerous outcomes from executing;
wherein the central machine with the system's service running on the central machine can either be in the cloud and operate through software as a service, or can be hosted at the customer's site;
wherein there is a support admin;
wherein there is a support agent,
wherein there is a request for support by an agent on a customer machine to the service on the central machine;
wherein there is an approval of support from the support admin to the service on the central machine;
wherein there is a notification of approval from the service on the central machine to the agent on a customer machine;
wherein a support agent requests connection to the customer machine's environment from the service on the central machine;
wherein there is an establishment of a connection between the support agent and the customer machine through the service on the central machine;
wherein a support agent sends commands to execute on the service on the central machine;
wherein the service on the central machine relays commands or scripts from the support agent to the customer machine.

16. A method for software diagnostics and resolution, the method comprising:
a service on a central machine;
the ability of the service on the central machine to access the target systems, such as servers, devices, and any dependent resources, either directly through a native agent, or through a custom agent, or through an agent installed by a third party;
the ability of the target systems to connect remotely to the service on the central machine;
wherein communication between the central service and either the agent on the target systems or the target systems themselves can be either real-time or message based, and can be either Pull or Push model, wherein the Push model is a service that sends a message either to the target systems or to the agent service without needing the agent to poll, and the Push model allows either the agent or the target systems to periodically poll for new messages, or poll for messages based on various triggers;
wherein the target systems can run scripts and commands locally that are sent from the service on the central machine;
wherein the set vice on the central machine allows IT admins to supervise DevOps personnel by following DevOps personnel actions live or through recordings,
wherein the service on the central machine allows IT admins to restrict access to types of software based on user type and specific user,
wherein the service on the central machine allows IT admins to restrict the duration of access to target systems based on user type and based on specific user,
wherein the service on the central machine records actions and their effects on customer machines,
wherein the service on the central machine analyzes the cause of incidents by utilizing traceability through the recordings of actions,
wherein the service on the central machine provides recommended actions to DevOps personnel in order to solve incidents,
wherein the service on the central machine is a passthrough system and thereby has access to all data going into the system.

17. The method of claim 16,
wherein the method constantly analyzes and builds the reputation for personnel who have used or are using the system based on past success rates, time taken, and user feedback;
wherein the method builds known skillsets and expertise for personnel who have used or are using the system based on the list of actions that personnel who have used or are using the system have taken, which is stored as data;
wherein the method uses the reputation, skillsets and expertise to recommend personnel for certain tasks;
wherein the method uses the reputation, skillsets and expertise to advertise the personnel with those skillsets and expertise,
wherein the method uses the reputation, skillsets and expertise to find the correct personnel for a task that a user wants to get done.

18. The method of claim 16,
wherein the service on the central machine predicts and recommends possible resolution steps based on its historical data by utilizing machine learning and data analytics;
wherein the service on the central machine will keep track of previous attempted resolutions, determine how successful they were, and based on that historical data and analytics, recommend a solution to the user;
wherein the recommendation will have possible percentage success rates, as well as user feedback for each possible solution.

19. The method of claim 16,
wherein the method provides live sessions for IT admins and other users, such that session sharing or screen sharing, or both session sharing and screen sharing is possible, and troubleshooting can take place with multiple users, and each user can either:
a. Passively watch and monitor, or
b. Actively participate and run commands, or
c. Shadow and get training.

20. The method of claim 16,
wherein the service on the central machine provides a platform where manual, semi-automated and automated steps are done during diagnostics, troubleshooting and resolution sessions;
wherein the service on the central machine implements change requests on the system;
wherein the service on the central machine executes commands via a provided console (DRS DevOps Console);
wherein the DRS DevOps Console will let engineers and support personnel use command line commands, scripts, files and any required access in order to accomplish their tasks;
wherein the DRS DevOps Console will offer Remote Desktop services, PowerShell options, Command Prompt access, and secure shell (SSH) access;
wherein the DRS DevOps Console provide contextual help and intelligence on top of native features;
wherein the DRS DevOps Console and the service on the central machine will have access to the target systems either directly, remotely, through an agent installed on the target system or through an intermediate system;
wherein the DRS DevOps Console will record all the steps taken, commands executed, and queries run in real-time or near real-time as the engineer performs the tasks;
wherein the outcome of such commands can also be recorded, including the success or failure of a command, and the output of a command;
wherein after a command is completed through the DRS DevOps console, or through the Service on the central machine for unattended sessions, all the actions performed to achieve the desired state are available for anyone authorized;
wherein the steps and actions performed during the issue resolution or change request sessions can be exported and used for quickly putting together new automation scripts or updating existing scripts to enable quicker and less error prone processes for the same or similar tasks in the future;
DRS DevOps console also provides Role Based Access Control, Just In-Time Access, Just Enough Access, White Listed or Black Listed allowable actions and commands, and Realtime Collaborative sessions.
